(19) United States
(12) Patent Application Publication
(10) Pub. No.: US 2009/0222308 A1
(43) Pub. Date: Sep. 3, 2009

(54) DETECTING FIRST PARTY FRAUD ABUSE

(76) Inventors: Scott M. Zoldi, San Diego, CA (US); Derek Malcolm Dempsey, London (GB); Maria Edna Perez Derderian, Escondido, CA (US); Jacob Spoelstra, Carlsbad, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/397,186

(22) Filed: Mar. 3, 2009

Related U.S. Application Data
(60) Provisional application No. 61/033,351, filed on Mar. 3, 2008.

(51) Int. Cl. G06Q 40/00; G06N 5/02; G06Q 10/00

(52) U.S. Cl. 705/7; 706/52; 705/30; 705/38

(57) ABSTRACT

A computerized method includes analyzing data associated with a credit line during an origination stage for predictive variables for use in a model for first party fraud, and flagging an account during the origination stage when at least one or more predictive origination stage variables cause a model score to exceed a pre-defined fraud likelihood threshold. The computerized method also includes analyzing data associated with one or more previously flagged, post-booked stage credit lines for data elements or transactions to be used as variables in a model to predictive of first party fraud at the customer-level or in one or more of the post-booked stage credit lines.

### RELATED APPLICATION

This application claims the benefit of U.S. Pat. No. 61/033,351, entitled “Detecting First-Party Fraud Abuse” filed on Mar. 3, 2008, the contents of which are hereby fully incorporated by reference.

### TECHNICAL FIELD

Various embodiments described herein relate to apparatus, systems, and methods associated with an apparatus and method for detecting first party fraud.

### BACKGROUND INFORMATION

In the past, analytics and predictive models have been used to detect third party fraud. This is typically the detection of fraud associated with a credit line by a party other than the account holder. Generally, a credit card is stolen, or electronic information related to the credit card is stolen. A third party, posing as the owner of the card, then uses the card to make purchases of various items from one or more vendors. The items can include actual merchandise, services, cash advances, gift cards, or the like. The third party, posing as the owner of the card, defrauds merchants out of merchandise and leaves the account owner with a bill for the purchases made fraudulently. The true account holder must then rectify the fraudulent charges with the issuer of the card. In many instances, the banks that issue the cards will limit the fraud responsibility that the account holder must repay. In some instances, the bank will not require the account holder to pay any amount that the third party spent. These limitations on account holder liability allow the account holder to have more confidence in owning and using the credit card to access their credit line.

Most of the time, the losses resulting from third party fraud are considered part of the operating expenses associated with the credit card that the bank extends to consumers. Banks, like any business, desire to minimize loses to insure larger profits. As a result, analytics and predictive models have been used to detect such fraudulent card usage early or shortly after the fraudulent activities begin taking place. Third party fraud is easy to define (and verify with the true account holder) and is a typical way fraudsters defraud merchants, and the financial institutions that issue the credit cards to consumers. As a result, much attention has been directed to detecting this type of fraud even though it accounts for about 0.1% of transactions associated with financial institution credit cards.

### SUMMARY OF THE INVENTION

This invention recognizes another type of fraud called first party fraud. In first party fraud, an entity opens a credit account or utilizes a line of extended credit, such as overdraft protection on direct deposit accounts (DDA accounts) with no intention of paying back the extended credit. The entity is content for the account to become delinquent and later written off. The entity may either be a real person (or company) or a bogus person or bogus entity. Thus, the information provided by the true-name or false-name entity to open the account, may include some falsified information either related to the identity or falsified financial information designed to acquire a larger line of credit to defraud the bank. The intent of the first party fraudster is to gain a credit line and to typically either not make a single payment (never pay) or to make minor payments to be granted larger credit limits to increase an overall amount of money taken when they run up the credit line and finally default. The intent of the first party fraudster either true-name or false name is to not pay back the lending institute for the line of credit utilized. Because the bank customer is committing the fraud, the credit issuer may have difficulty in contacting the bank customer when the card or extended credit line goes to a delinquent status. In some instances fake contact information may be provided. In other instances, the individual may leave the country. These types of fraud scenarios, namely first party fraud scenarios, have increased dramatically over the past few years particularly as traditional third party fraud has been clamped down upon by analytic fraud detection solutions.

In many instances, the first party fraud goes unrecognized by credit issuers. In addition, since it is not recognized, most of the time first party fraud is not reported as fraud and it is treated the same as other accounts in bad debt collections. Normal collection attempts are ineffective for first party fraud as entities engaging in this scheme have no intention of repaying the obligation incurred. In fact, in first party fraud the entity may have never had any intention of repaying the obligation. In some instances, fake entities are being formed over the course of many years to look like they may be entities intending to repay their obligations. In many instances, the entity can not even be located, so there is very little recourse for this type of fraud. In many instances, this fraud is classified as “bad debt” and written off by the financial entity issuing the credit. First party fraud is thought to be at least ten times more prevalent than third party fraud. In the credit card space, first party fraud is assumed to account for 1.0% of all transactions associated with a financial institution's credit cards. As a result, there is a need to detect and predict this type first party fraud to limit the issuer's exposure to this type of fraud and misclassification and action as bad debt.

### BRIEF DESCRIPTION OF THE DRAWINGS

FIG. 1 is a schematic diagram of a computer system, according to an example embodiment.

FIG. 2 is a schematic diagram of a computer system, according to an example embodiment.

FIG. 3 is a flow diagram of a method associated with the computer system, according to an example embodiment.

FIG. 4 is a schematic diagram of a medium that includes a set of instructions, according to an example embodiment).

FIG. 5 is a schematic diagram of a system architecture associated with the computer system, according to an example embodiment.

### DETAILED DESCRIPTION

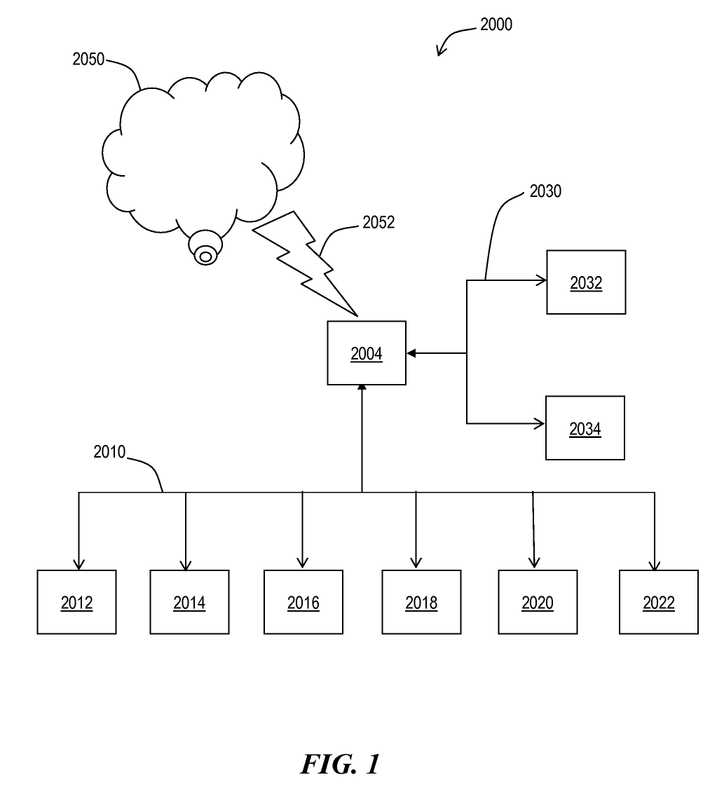

A block diagram of a computer system 2000, according to an example embodiment of this invention, is shown in FIG. 1. The computer system 2000 may also be called an electronic system or an information handling system and includes a central processing unit 2004, a memory and a system bus 2030. The information handling system includes a central processing unit 2004, a random access memory 2032, and a system bus 2030 for communicatively coupling the central processing unit 2004 and the random access memory 2032. The information handling system 2000 includes a disc drive device which includes the ramp described above. The information handling system 2002 may also include an input/output bus 2010 and several devices peripheral devices, such as 2012, 2014, 2016, 2018, 2020, and 2022 are attached to the input output bus 2010. Peripheral devices may include hard disc drives, magneto optical drives, floppy disc drives, monitors, keyboards and other such peripherals. One of the peripheral devices, such as 2022 includes a display. The display presents information to a user. The display 2022 may be configured to elicit information and commands from the user. The commands and information are converted to inputs and placed on the input output bus 2010 for transport to the processing unit 2004. The processing unit may also place outputs on the input output bus 2010 for presentation at the display device 2022.

In some embodiments, the computer system 2000 may operate in a networked environment using a communication connection to connect to one or more remote computers. As shown in FIG. 1, the computer system 2000 is communicatively coupled to a network 2050 through a link 2052. The link 2052 can be wired or wireless. The remote computer can be a single computer or a plurality of computers, such as a local area network, wide area network, or the internet. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 2004 of the computer system 2000. Computer-readable instructions may be stored in the random access memory 2032 or in the read only memory 2034. In addition, computer readable instructions may be stored in peripheral devices, such as 2012, 2014, 2016, 2018, 2020 or 2022. A hard disk drive, CD-ROM, a tape drive or any similar storage device are some examples of a computer-readable medium that may be a peripheral attached to the input output bus 2010. In addition, a remote computer associated with the network 2050 may store a set of computer-readable instructions. These instructions can be sent to the processor 2004 over the link 2052 which communicatively couples the processor 2004 to the network 2050. Therefore, the machine-readable or computer-readable instruction set may not be resident on the computer 2000 but can also be transported over the network 2050 to the computer 2000.

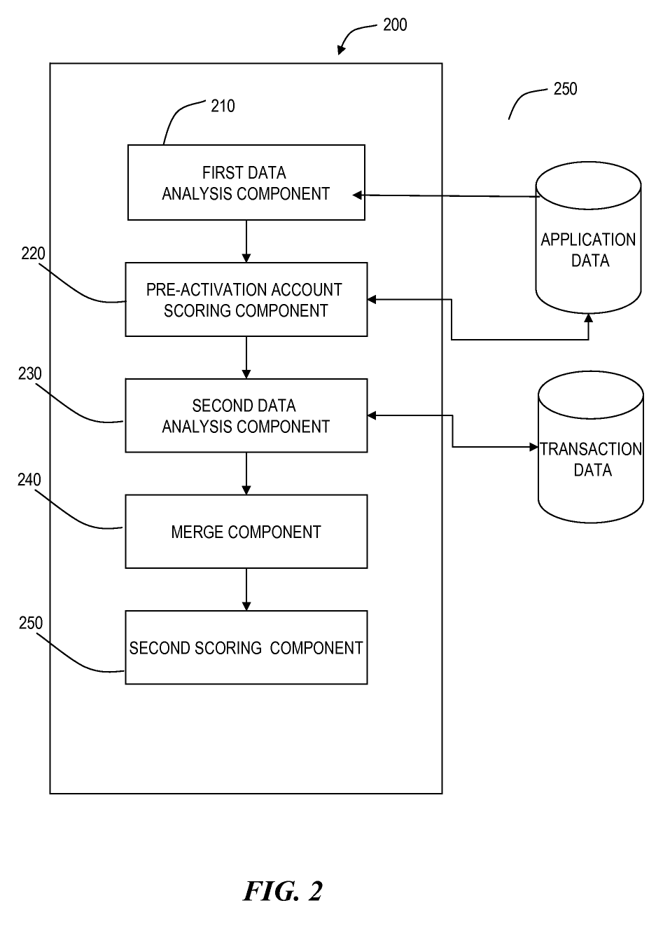

FIG. 2 is another schematic diagram of a computing system 200 that includes a plurality of components formed by the computer system 2000 (shown in FIG. 1) and the machine-readable or computer-readable instructions, according to an embodiment of the invention. The computer system 200 may be a combination of software and hardware. The computer system 200 does not have to be located in one physical location. In some example embodiments, the computer system may include a portion which is remote from the physical location of the remaining portions of the computer system 200. The computing system 200 includes a first data analysis component 210, a pre-activation account scoring component 220, and a second data analysis component 230. The first data analysis component 210 analyzes data associated with an application for credit line during an application, pre-activation stage for predictive variables for use in a model for first party fraud. The pre-activation account scoring component 220 flags an account during the application, pre-activation stage when at least one or more predictive pre-activation stage variables of first party fraud cause a fraud score to exceed a pre-described fraud likelihood threshold. The second data analysis component 230 analyzes data associated with post-booked stage credit lines for transactions, including customer information updates, customer contacts, request for additional credit limit, payments, purchases, and the like, to be used as variables in a model to predict first party fraud in one or more of the post-booked stage credit lines. The post-booked model may bring in transaction histories associated with one or more credit lines to allow for a customer-level and account level assessment of probability of first party fraud. The second data analysis component 230, in some embodiments, analyzes the transactions during a selected, initial time period after approving the credit line. In many instances, the accounts that were risky but not closed during the first or application, pre-activation state, will be the accounts that are analyzed by the second data analysis component 230. In another embodiment the account may be analyzed using the first data analysis component 210 shortly after the account is opened. The analysis includes scoring the account initially. If the account is over a selected threshold initially, the account is flagged and the account is analyzed using the second data analysis component 230. The second data analysis component 230 is designed in some embodiments to update account and customer transaction profiles of recursive fraud variables to update the probability of first party fraud with each transaction associated with a particular credit line and/or the customer profile.

In some embodiments, the computer system also includes a merge component 240 and a second scoring component 250. The merge component 240 merges a first party fraud score associated with the application, pre-activation stage with first party fraud variables associated with transaction data and derived account and customer profiles from the post-book stage data analysis component 230. The merged information is then scored using the second scoring unit 250 to produce a second first party fraud score associated with the post-book stage at the account and customer level. The score from the second scoring unit 250 indicates the likelihood of first party fraud. Various actions or inactions can be triggered based on the score from the second scoring unit 250. For example, a payment has been received on the account but has not cleared then a clearing house credit availability may not be updated until funds clear. Based on the fraud score in unit 250, if a request for increased the line of credit comes in, the recommended action may be to delayed or denied based on the first party fraud score. If first party fraud occurs or is suspected on one of the accounts associated with a particular customer, this may cause different actions on the further lines of credit associated with the customer. For high fraud scores, the credit line may be reduced, customer contact phone or mail (to test the validity of customer information on file) may be initiated, or purchases may be blocked. The fraud score and reason codes related to the main drivers of the fraud score can also be used in an account management strategy and reflected in credit portfolio management.

This invention detects first party fraud. As mentioned above, in first party fraud, an entity (also known as the first party or customer) opens a credit account with no intention of paying back the extended credit. One of the key aspects of first party fraud is that the owner of the account has no intent to pay back the obligation. As a result, several behaviors are common amongst first party fraudsters. The behaviors result from the lack of intent to pay back the credit obligation. In many instances, first party fraudsters open an account with either true or partially/fully false information. In the beginning, the individual transacts heavily on the account to give the appearance of creditworthiness. The first party fraudsters may also take actions to boost credit limits. The boost of the credit limit may be artificial, transacting as a sleeper (behaving like a customer in good standing later to defraud the financial institution), or through manipulation of behavior scores utilizing a variety of open accounts to give the appearance of proper management of credit. Generally, the individual will request higher credit limits or additional loans. Since the individual has no intention of paying on the obligation, these actions are taken to increase the amount of goods or services the first party fraudster will obtain fraudulently by his or her actions. Typically, the individual takes the maximum credit limit amount possible from the account unless trying to behave as a sleeper who will build the credit limit over time before defrauding the financial institution. The maximum on the credit line is generally not enough for the first party fraudster. When additional credit lines are extended, the individual may make a payment and spend up to the new maximum. The payment will make more credit available on the credit line, but the payment may be fraudulent, and will “bounce”, resulting in situations where the individual is severely over their credit limit. Once severely over the credit limit, the first party fraudster fails to pay anything, and the account is passed to the collections department. The first party fraudster typically “skips town” or disappears or changes their identity. The debt is typically written off as bad debt since there is no victim of fraud and the lack of process at some financial institutions to classify bad debit as first party fraud. In some instances, the first party fraudsters also make false claims of fraud, to represent themselves as victims of a fictitious 3^{rd} party fraudster. These behaviors manifest themselves in first payment defaults or very early defaults, amounts outstanding are typically excessively over the credit limit, have poor cure rates, and typically are accompanied by the inability of contacting the individual or individuals responsible for the credit obligation. This fraud scenario has increased dramatically over the past years particularly as traditional third party fraud has been clamped down upon by analytic fraud detection solutions

The proposed method 300 is a one-two stage predictive model. The method 300 for determining the presence of first party fraud includes an analysis of the account in a first origination phase or stage, either before the account has been approved, or, in other instances, shortly after the account has been approved to set credit limits or account strategies, particularly where account origination is guaranteed. If the first origination phase analysis is done prior to approving the credit line, the origination phase is also referred to as the application, pre-activation phase or the pre-booked stage. If the origination phase analysis is done shortly after approving a credit line, it may be referred to as an application post-activation stage. The application, bureau, and third party identity verification information are analyzed and variables predictive of first party fraud are created and used in an analytic model that will make predictions of fraud/non-fraud based on an estimate of probability of fraud. Variables in the originations phase will include risk tables associated with application attributes historically that has shown higher levels of fraud. The attributes can include profiling of dealers, customer service representatives, and branches where applications are gathered to determine patterns of collusion and improper processing. Analyzing data associated with a credit line during the pre-booked portion or post booked portion of the origination stage may includes profiling of at least one entity associated with the originations process, such as a dealer, a branch of a financial institution or other institution, or customer service representative or set of customer service representatives. The collections of applications can be reviewed based on those common linking attributes may indicate the methods that first party fraudsters use to gain access to credit. In some instances, adaptive analytics techniques will update fraud indicators associated with the fraud variables to reflect the speed at which first party fraudsters will change tactics in response to a first party fraud model score. The variables are placed in a model which is used to predict the probability of first party fraud. When there is an indication of first party fraud in the application, pre-activation/post-activation stage (first stage), the line of credit may be closed pending additional customer verification such as confirmation of contact details. In other instances, the line of credit may still be issued, however, the account will be earmarked as being potentially subject to first party fraud. The data and transactions on the earmarked account will then also be monitored or checked for further indications of first party fraud such as confirmation of contact details/application details, and/or analysis of the customer behavior post-activation including customer payments, contacts to customer service, payment behavior, and credit line utilization patterns. This data, also referred to as data associated with the post-booked stage, will be analyzed for variables used in models to predict the likelihood of first party fraud. Variable creation will include profiling of credit account activities and customer activities such as address change patterns, contact failure patterns, payment followed by available credit changes, credit limit requests, and transaction purchase signatures such as changes form a sleeping transaction patterns (patterns more typical of normal good customers) to high frequency or high dollar spending patterns (more accustomed with fraudulent use of a credit line). Of course, the account will also be monitored for other traditional forms of fraud as well. Monitoring during the post-activation phase in some embodiments will be continuous with the various fraud profile variables being updated with each and every transaction received on the account and the associated customer.

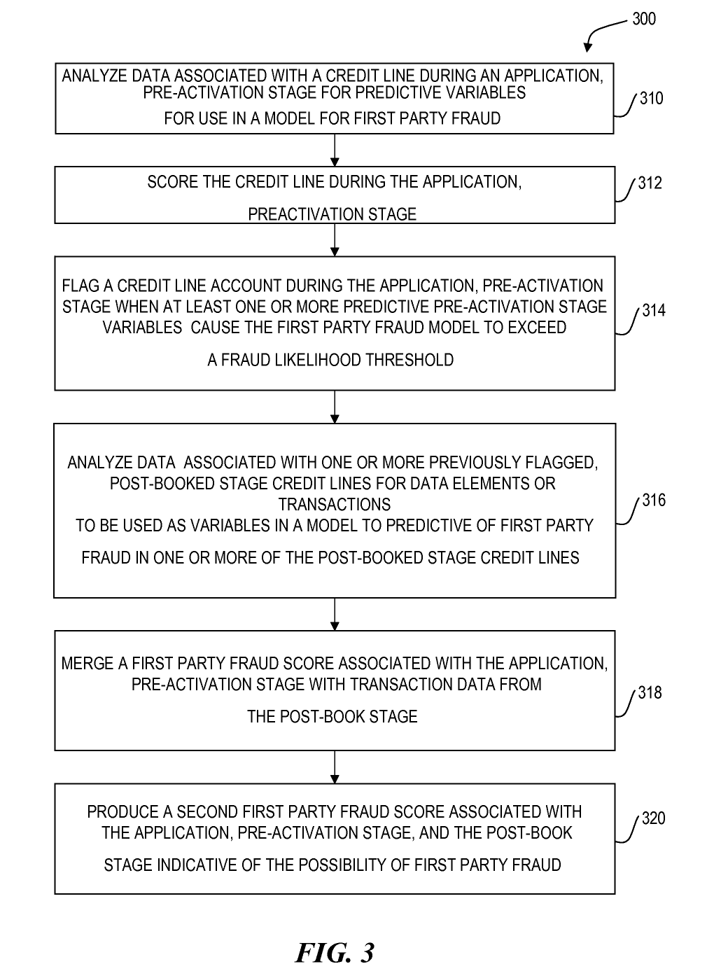

The computer system 200 as shown in FIG. 2 and generally shown as a computer 2000 in FIG. 1, carries out a computerized method 300. FIG. 3 shows a flow diagram of the computerized method 300, according to an example embodiment. The computerized method 300 includes analyzing data associated with a credit line a credit application during an first origination stage (application, pre-activation/post-activation stage) for predictive variables for use in a model for first party fraud 310, and scoring a credit line application, pre-activation/postactivation or origination stage 312 and flagging a credit line account during the application, pre-activation stage when at least one or more predictive pre-activation stage variables cause the first party fraud model to exceed a fraud likelihood threshold, 314. The predictive originations stage variables may result in flagging 314 when the fraud score from scoring the credit line during the application, originations stage 312 exceeds a pre-described fraud likelihood threshold.

The computerized method 300 also includes analyzing data 316 associated with one or more previously flagged, post-booked stage credit lines for data element or transaction variable signatures to be used as variables in a model to predictive of first party fraud in one or more of the post-booked stage credit lines. In one embodiment, analyzing data associated with the credit line during the application, originations stage 312 for predictive variables includes analyzing the information provided by an entity applying for the credit line for false information. In other embodiments, analyzing data associated with a credit line during the post-booked stage 316 includes analyzing the transactions during a selected time period, such as an initial time period after approving the credit line. Analyzing the data 316 during the selected initial time period includes one or more other analyses, such as analyzing the velocity of the transactions, analyzing the size of the transactions, analyzing the type of payment for the transactions, analyzing the type of customer contacts associated with the credit line, or analyzing the type requests for additional credit. In still other embodiments, the data associated with the account is analyzed during the initial period after approval 316 for the amount paid on the account and whether the payment on the account has been received and cleared before request for updated available credit. In some instances, even if payment has been received, the account is checked to see if the payment has not yet cleared. Analyzing data associated with one or more credit lines that have previously been flagged 316, may also include searching for a condition where there is a request for an increase in a credit limit associated with the credit line. Determination of likelihood of first party fraud 316 can include fraud profile variables from one or more accounts owned by a customer to provide a complete customer-view of the first party fraud risk reflecting other account activity in the determination of customer-level first party fraud risk.

In still other embodiments, the computerized method 300 also includes attempting to contact the entity associated with a flagged account 318. In other words, the identity of the account contact is verified or it is determined that the contact information is false. In still other embodiments, the computerized method 300 includes merging a first party fraud score associated with the application, originations stage with transaction data variables from the post-book stage 320. The merged data or computed profile variables are then scored to produce a second first party fraud score associated with the application, originations stage, and the post-book stage 322. In this embodiment, the second score provides a likelihood of first party fraud when looking at both the originations stage and the post-booked transacting stage. In some embodiments, the post-book profile variables and the associated merged score 320 are updated in real-time with each new received transaction associated with the customer or their credit accounts. In some embodiments, the first originations first party fraud score is used to trigger which of the post-booked credit lines will be scrutinized for an indication of first party fraud using further analysis and further scoring based on credit line transactions and customer behaviors.

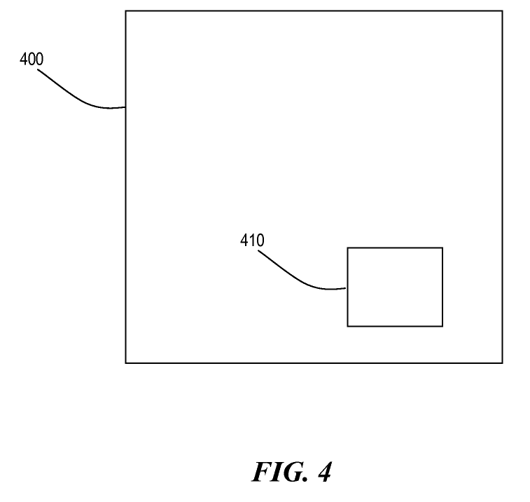

FIG. 4 is a schematic diagram of a machine readable medium 400, according to an example embodiment. The machine readable medium includes a set of instructions 410. The machine-readable medium 400 provides instructions that, when executed by a machine, cause the machine to: analyze data associated with a credit line during an origination stage; flag an account during the origination stage; and analyze data associated with one or more previously flagged, post-booked stage credit lines. The analyses and flagging yield indications and predictions regarding first party fraud. The analysis for the originations stage is for predictive variables for use in a model for first party fraud. Variables in the originations phase will include risk tables associated with application attributes that historically have shown higher levels of fraud. These attributes can include profiling of dealers, customer service representatives, and branches where applications are gathered to determine patterns of collusion and improper process based on collections of applications based on those common linking attributes. Some of these attributes indicate the methods that first party fraudsters use to gain access to credit. In some instances, adaptive analytics techniques will update fraud indicators associated with the fraud variables to reflect the speed at which first party fraudsters will change tactics in response to a first party fraud model score. The account is flagged during the application, stage when at least one or more predictive origination variables of first party abuse cause a fraud score to exceed a pre-described fraud likelihood threshold.

After the previously flagged credit line is approved, it is further analyzed for transactions data elements to be used in the creation of variables in a model to predict first party fraud in one or more of the post-booked stage credit lines and at the customer-level. Variable creation will include profiling of credit account and customer activities such as address change patterns, contact failure patterns, payment followed by available credit changes, credit limit requests, and transaction purchase signatures such as changes form a sleeping transaction patterns (patterns more typical of normal good customers) to high frequency or high spending patterns (more accustomed with fraudulent use of a credit line. Again the data elements or transactions selected tend to predict first party fraud or the probability of first party fraud. When indications of potential first party fraud are found in the application, originations stage, many times it is more likely that indications predictive of first party fraud will be found after approving the credit line and it may cause the predicted probability of fraud to be higher. Many financial institutions may use the origination score to block the bad applications or to quickly identify potentially bad customers. The moderately risk customers from the originations stage are closely monitored based on their post-book activity and transactions once the credit line is granted. In some embodiments, the machine-readable medium 400 provides instructions 410 that, when executed by a machine, further cause the machine to analyze transactions associated with the post-booked stage credit lines during a selected, initial time period after approving the credit line. In some embodiments, the instructions 410 further cause the machine to merge a first party fraud score associated with the application or origination stage with transaction data from the post-book stage to produce a second first party fraud score associated with the application and the post-book stage which is updated based on profile variables that are updated with each subsequent transaction in the post-booked phase. The score results in an indication or prediction of first party fraud based on both the application, pre-activation stage and the post-book stage.

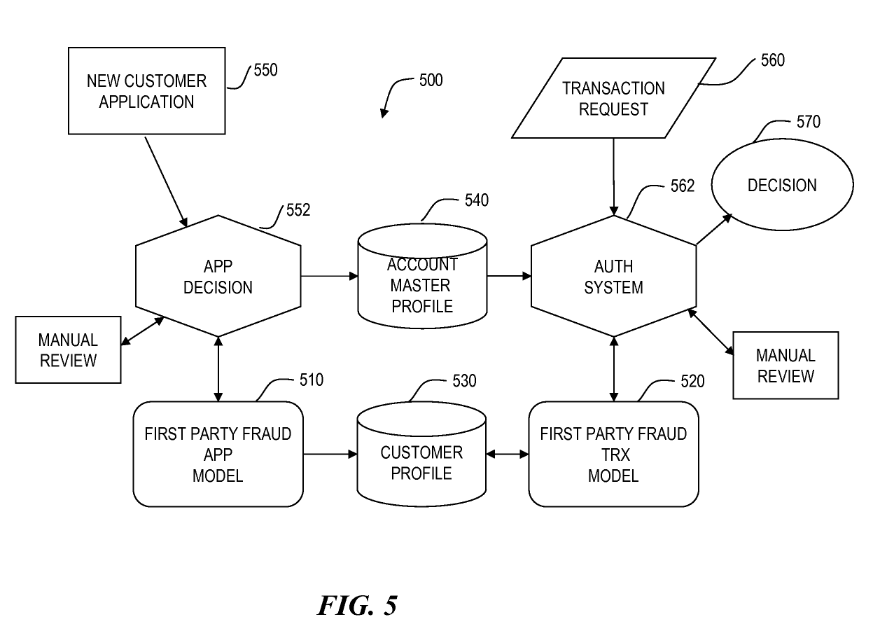

FIG. 5 is a schematic diagram of a system architecture 500 associated with the computer system 200, 2000, according to an example embodiment. The system architecture 500 includes a first model 510, and a second model 520. The first model 510 is formed from analyzing historical data related to new customer applications or new customers at the origination stage to find variables indicative of first party fraud abuse transactions that can be used to form an analytic model score based. The second model 520 is formed from analyzing historical data related to customer transactions and credit line transactions and subsequent payment activity from suspected or known first party fraud customers. Profile variables indicative of first party fraud transactions are used to form the model 520. The system architecture 500 also includes a customer profile 530 and an account master profile 540. In addition to these profiles associated with the customer, one or more profiles may be utilized to create variables for models 510 and 520 which can include profiles of dealers, branches, and customer service representatives to find commonality in how first party fraud in perpetrated both in the originations and post-book transaction stage of a customer lifecycle. In addition, the system 500 also includes an input 550 for the customer application. The input 550 is input to an application decision portion 552. The model 510 retrieves selected variables from the data input as well as other data such as credit bureau information and/or identity verification information to the application decision portion 552. The model 510, in some embodiments, scores the application information and inputs the score to the application decision portion 552. A decision is made on whether to extend credit to the entity or person. Another decision may be made to action the customer account differently based on the risk of first party fraud based on characteristics in the origination stage. The decision and other data including the application score are forwarded or accessible by the account master profile 540. The score from the first model 510 is also forwarded or accessible by the customer profile 530. A score indicative of potential for first party fraud can therefore, be found in one or both of the account master profile 540 and the customer profile 530. Thus, the entity can be earmarked for special consideration by the second model 520, which tracks potential first party behavior based on transactions that occur after an account has been opened. This is also referred to as the post-booked stage. In other embodiments of the invention, all customers in the post-booked stage are monitored for first party fraud regardless of the risk associated with the originations fraud score 510.

The system architecture also includes a transaction input 560 to a transaction system portion 562. The transaction system, 562, will process credit line utilization requests (purchases/funds transfer), customer contacts, payments, credit line requests, customer information updates, and the like. Once earmarked as potentially subject to first party fraud abuse in the origination stage (or not in other instantiations), the second model 520 profiles the transactions associated with the account and the current transaction request 560 input to the transaction system portion 562 for the creation of first party fraud variables used in the second model 520. The second model 520 scores the transaction request in view of the score from the first model 510 and information in the account master profile 540 and the customer profile 530. This score based on transaction profile variables from the customer profile and one ore more account master profiles is input to the transaction system portion 562. A decision 570 is made with respect to the transaction request based on the various pre-booked and post-booked behaviors, and the associated fraud score. Of course, the transaction system portion 562 may be reviewed manually which results in a case being generated to be worked within a case management system that aggregates all transaction history associated with the customer and their line of credit. In other embodiments, the first party fraud scores, reason codes associated with the model scores, and portions of the transaction information will be sent to an account management system to apply account management strategies to accounts/customers that are suspected of committing first party fraud.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments and other embodiments not specifically described herein will be apparent to those of skill in the art upon reviewing the above description.

The Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A computerized method comprising:
analyzing data associated with a credit line during an origination stage for predictive variables for use in a model for first party fraud;
flagging an account during the origination stage when at least one or more predictive origination stage variables of first party cause a fraud score to exceed a pre-described fraud likelihood threshold;
analyzing data associated with one or more previously flagged, post-booked stage credit lines for elements to be used in a model to predict first party fraud in one or more of the post-booked stage credit lines.

2. The computerized method of claim 1 wherein the elements associated with analyzing data associated with one or more previously flagged, post-booked stage credit lines includes data;

3. The computerized method of claim 1 wherein analyzing data associated with a credit line during a pre-booked portion of the origination stage includes profiling of at least one entity associated with the originations process.

4. The computerized method of claim 1 wherein the elements associated with analyzing data associated with one or more previously flagged, post-booked stage credit lines includes computed variables.

5. The computerized method of claim 1 wherein analyzing data associated with the credit line during the origination stage for predictive variables includes analyzing the information provided by an entity applying for the credit line for false information.

6. The computerized method of claim 1 wherein analyzing data associated with a credit line during the post-booked stage includes analyzing the transactions during a selected, initial time period after approving a credit line.

7. The computerized method of claim 6 wherein analyzing the transactions during a selected, initial time period after approving the credit line includes analyzing the velocity of the transactions.

8. The computerized method of claim 6 wherein analyzing the transactions during a selected, initial time period after approving the credit line includes analyzing the size of the transactions.

9. The computerized method of claim 6 wherein analyzing the transactions during a selected, initial time period after approving the credit line includes analyzing the type of payment for the transactions.

10. The computerized method of claim 6 wherein analyzing the transactions during a selected, initial time period after approving the credit line includes analyzing the type of customer contacts associated with the credit line.

11. The computerized method of claim 6 wherein analyzing the transactions during a selected, initial time period after approving the credit line includes analyzing the type requests for additional credit.

12. The computerized method of claim 6 wherein analyzing the transactions during a selected, initial time period after approving the credit line includes analyzing customer information and address changes.

13. The computerized method of claim 11 wherein a payment on the account has been received.

14. The computerized method of claim 11 wherein a payment on the account has been received, and the payment has not yet cleared.

15. The computerized method of claim 1 wherein analyzing data associated with a credit line during the post-booked stage includes analyzing the transactions associated with a customer and one or more credit lines.

16. The computerized method of claim 1 wherein analyzing data associated with a credit line during the post-booked stage includes creation of transaction profile variables associated with the account and customer profiles.

17. The computerized method of claim 1 further comprising attempting to contact the entity associated with a flagged account.

18. The computerized method of claim 1 further compromising merging a first party fraud score associated with the application, origination stage with transaction data from the post-book stage to produce a second first party fraud score associated with the application and the post-book stage.

19. The computerized method of claim 1 wherein analyzing data associated with one or more credit lines that have previously been flagged includes searching for a condition where there is a request for an increase in a credit limit associated with the credit line.

20. A computer system comprising:
a first data analysis component for analyzing data associated with a credit line during an origination stage for predictive variables for use in a model for first party fraud;
an origination account scoring component that flags an account during the origination stage when at least one or more predictive origination stage variables of first party may cause a fraud score to exceed a pre-described fraud likelihood threshold;
a second data analysis component for analyzing data associated with one or more previously flagged, post-booked stage credit lines for transaction based profile variables to be used as variables in a model to predict first party fraud in one or more of the post-booked stage credit lines.

21. The computer system of claim 20 wherein the second data analysis component analyzes the transactions during a selected, initial time period after approving the credit line.

22. The computer system of claim 20 further compromising a merge component for merging a first party fraud score associated with the application, origination stage with transaction data from the post-book stage to produce a second first party fraud score associated with the origination stage and the post-book stage for the customer and one or more associated lines of credit.

23. A machine-readable medium that provides instructions that, when executed by a machine, cause the machine to:
analyze data associated with a credit line during an origination stage for predictive variables for use in a model for first party fraud;
flag an account during the origination stage when at least one or more predictive variables of first party fraud cause a fraud score to exceed a pre-described fraud likelihood threshold; and
analyze data associated with one or more previously flagged, post-booked stage credit lines for transaction based profile variables to be used as variables in a model to predict first party fraud in one or more of the post-booked stage credit lines.

24. The machine-readable medium of claim 23 that provides instructions that, when executed by a machine, further cause the machine to analyze transactions associated with the post-booked stage credit lines during a selected, initial time period after approving the credit line.

25. The machine-readable medium of claim 23 that provides instructions that, when executed by a machine, further cause the machine to merge a first party fraud score associated with the application, pre-activation stage with transaction data from the post-book stage to produce a second first party fraud score associated with the origination stage and the post-book stage.
